(19) United States
(12) Patent Application Publication
(10) Pub. No.: US 2003/0044579 A1
(43) Pub. Date: Mar. 6, 2003

(54) Anti-spalling laminated safety glass

(76) Inventors: Nelson Bolton, Trumbauersville, PA (US); Novis Smith, Philadelphia, PA (US)

Correspondence Address: John Lezdey, Suite A, 1409 North Fort Harrison, Clearwater, FL, 33755, US

(21) Appl. No.: 09/939,265

(22) Filed: Aug. 25, 2001

(51) Int. Cl. B32B 3/30

(52) U.S. Cl. 428/167; 428/220

(57) ABSTRACT

A method for preparing a transparent anti-spalling laminated article comprising a laminating layer which is an extruded copolymer having contiguous grooved or scored surfaces and transparent sheets of glass laminated to both surfaces of the layer:

The side of the laminate on the interior has a thickness of about 0.5 to 1.5 mm. The laminating layer is an extruded copolymer of olefins and an alpha olefin carbolxylic acid having a methacrylic or acrylic acid monomers in an amount of about 13 to 22% by weight.

### FIELD OF THE INVENTION

The present invention relates to anti-spalling laminated safety glass structures having good optical clarity. More particularly, the invention relates to the manufacture of laminated safety glass structures having a plurality of glass layers which have good optical clarity and are resistant to spalling and delamination. The safety glass structures may be used for aircraft, land vehicles, sidelights, severe storm window structures, and the like.

### BACKGROUND OF THE INVENTION

Energy absorbing laminates for use as safety glass is well known. Customarily, these products are formed from transparent materials of different compositions and are composed of an outer layer of one or more plies and an inner layer, which is bonded together with the outer layer by a resinous interlayer. Usually, a relatively thick glass outer layer is combined with at least one relatively thin inner layer.

Laminated safety glass must satisfy certain quality requirements according to the purpose for which it is to be used. In the case of motor vehicles, these quality requirements as laid down in the “Strassenverkehrszulassungsordnung” of the German Federal Republic, Section 22, No. 29, in “Motor Vehicle Safety Standards” Nos. 205 and 208, and in U.S.A. Standard Z 26.1-1966. Quality requirements for use in the building industry are established in “American national Standard Institute” Standard Z 97.1-1966, for use as bulletproof material they are specified in “Underwriters Laboratories” Standard 752.

For bullet-proof laminated safety glass and for windshields, it is generally believed that the inner layer should be a resinous material such as a polycarbonate in order to avoid spalling. Furthermore, it was believed that if the inner layer is glass, an antispall covering of a resinous material is necessary to reduce the risk of flying glass splinters upon impact.

The use of so-called safety glazing for windows, windshields, and the like using multiple layers of polycarbonate, glass and other resinous materials is well known. For example, glass-polycarbonate resin laminates are described in U.S. Pat. Nos. 4,66,228 and 3,666,614.

In U.S. Pat. No. 3,520,768 there are described laminate's of relatively thick glass having a comparatively thin polycarbonate foil as the cohering layer. While generally useful, these laminates suffer from an inability to withstand multiple shots, especially when struck by high velocity bullets such as those fired from rifles. Thus, for example, in prior art laminates using thick forward facing (impact receiving) glass plies, multiple shots at the thick glass front ply cause much glass cracking and removal of the glass from the laminated structure, making it vulnerable to repeat hits. In order to withstand the repeated hits, the laminates had to be extremely thick and heavy. Even these thick and heavy laminates were not entirely successful, since spalling on the backside or downstream face of said laminates occurred with the resultant danger of injury due to this spalling to persons behind these laminates.

Thus, there is a need for laminates which are capable of withstanding repeated high velocity strikes without penetration and/or spalling of the back or downstream layers.

U.S. Pat. No. 4,125,669 to Triebel et al discloses a laminated safety glass which utilizes a thick outside layer of silicate glass which is bonded to a polycarbonate pane of at least 1.5 mm. Thick.

U.S. Pat. No. 4,312,903 to Molari discloses impact resistant, double glazed structures comprising a plurality of laminae selected from polycarbonate, glass and solid resinous materials. The glass laminae faces the direction of impact and has a thickness from about 30 to 220 mils. The structure utilizes relatively thick outward layers and relatively thin inward layers.

U.S. Pat. Nos. 4,663,228 and 4,799,346 to Bolton et al, which are herein incorporated by reference, disclose laminated safety glass structures which are preferable for use in the present invention. However, the onward layers disclosed in this patent have a thickness which would not provide the anti-spalling characteristics of the present invention.

In the specification and claims the terms an “extrudable polymer” comprising neutralized or partially neutralized polyolefin, preferably ethylene, and alpha olefin-carboxylic acid copolymers and mixtures thereof of particular interest are the copolymers preferably prepared from a combination of ethylene or propylene monomers and acrylic acid and methacrylic acid. Furthermore, of particular significance are the alkali metal cation neutralized ethylene or alpha olefin-carboxylic acid copolymers, i.e. methacrylic or acrylic acid, copolymers. Properties which distinguish the copolymers from other polyolefin heat-seal polymers are their high clarity, melt strength, and solid-state toughness.

The terms “knurled, scored or embossed surface” as used herein include any form of contiguous grooved surface including those prepared with crimping, cutting, embossing and knurling apparatuses.

The term “inner glass layer” means the glass layer which is in the interior of a structure facing a passenger or the subject to be protected.

### SUMMARY OF THE INVENTION

According to the present invention, there is provided an optically transparent anti-spall laminate composed of at least one extruded laminating film, an inner glass sheet having a thickness of about 0.5 to 1.5 mm. laminated on one side of said laminating film and at least one glass sheet on the other side. The process comprises the steps of:

A. providing a multiplicity of contiguous grooves or scores on at least one surface of a 4 to 60 mils. in thickness laminating film, said laminating film being an extruded copolymer of a polyolefin and about 13 to 22% by weight of an alpha olefin carboxylic acid, said laminating film containing 0 to 5% by weight of a diamine and is at least partially neutralized with an alkali metal cation;

B. placing the inner glass sheet and an outer glass sheet in contact with the grooved or scored surfaces of the laminating layer, and then;

C. applying sufficient heat and pressure to the combination to form a laminate.

It has been found that when the laminating film is contiguously grooved or scored, gases and bubbles, which commonly form between the layers when the assembly is heated, are easily removed. The grooved or scored surface disappears as the temperature rises and pressure is applied.

Advantageously, the laminating layer comprises an extruded copolymer composition comprising a polyolefin and from 13 to 22% by weight of methacrylic and/or acrylic acid monomers, which have been neutralized from 40 to 90% with an alkali metal cation and which has a Tg of less than 210° F.

Preferably, the assembly is placed prior to heating in a sealed container or a bag of the type disclosed in U.S. Pat. No. 3,311,517, which is herein incorporated by reference.

The assembly may be heated in an oven and then passed through nip rollers to accomplish the lamination. This can then be followed by autoclave treatment without bagging.

The assembly is treated in a conventional manner such as disclosed in U.S. Pat. No. 4,668,574. That is, the assembly is heated to a temperature about 255-280° F. and under a pressure of about 20 to 200 psi. Advantageously, after the heat treatment under pressure the assembly is cooled to a temperature of about 150° F. within a period of about 30 to 45 minutes to prevent clouding.

The method of the invention can be used to form laminates having a thin single inner glass sheet, a bonding layer sandwiched between said single glass sheet and a second glass sheet or multi-layered laminates as described in U.S. Pat. No. 4,619,973, which is herein incorporated by reference.

It is an object of the invention to provide a process for preparing a laminate which is anti-spalling and possesses high optical clarity.

Other objects and a fuller understanding of the invention will be had by referring to the following description and claims of a preferred embodiment, taken in conjunction with the accompanying drawings, wherein like reference characters refer to similar parts throughout the several views.

### BRIEF DESCRIPTION OF THE DRAWINGS

FIGS. 1 and 1A are perspective views of a laminating film having contiguous grooved surfaces for use in the process of the invention;

FIG. 2 is an exploded view showing a grooved bonding film between a pair of glass sheets.

FIG. 3 is a front view partially in cross-section showing the laminate of FIG. 2, after being subjected to heat and compression;

FIG. 4 is a front view partially in cross-section showing a multi-laminate structure.

FIG. 5 is a perspective view of a laminating film having embossed surfaces.

### DESCRIPTION OF THE PREFERRED EMBODIMENTS OF THE INVENTION

Although specific terms are used in the following description for the sake of clarity, these terms are intended to refer only to the particular structure of the invention selected for illustration in the drawings, and are not intended to define or limit the scope of the invention.

It is understood that the following description omits many structural elements commonly found in laminating glazing units for aircraft, such as mounting frames, such as those in U.S. Pat. No. 3,081,205 to Shorr, electrical terminal blocks and special insulators for lead lines connecting bus bars for the defogging or deicing device of U.S. Pat. No. 3,410,739 to Orcutt, temperature sensing deices, such as those shown in U.S. Pat. No. 3,789,191 to Spindler, reinforcing frames such as those shown in the aforesaid Orcutt and Shorr patents and other structural elements well known in the art.

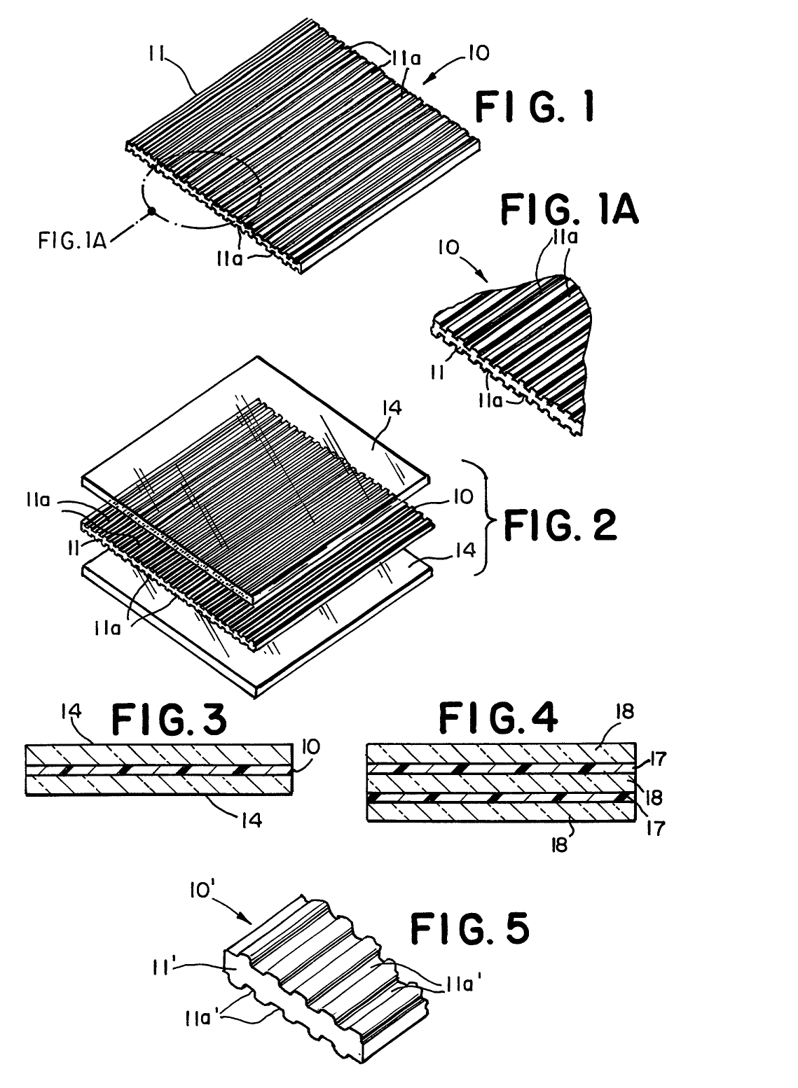

As illustrated in FIGS. 1 and 1A, a laminating layer 10, which is used as an interlayer between two optically clear sheets of glass, is provided with score or grooves 11, 11a on both sides. The grooved or scored portions permit the escape of off-gases during the laminating process of the invention. The scores 11, 11a are in the range of about 25 to 300 microinches deep and a maximum width of 300 microinches, preferably between 25-200 microinches. The direction of scoring is not critical, but should continue to the edge of the laminate to expel gases. In lieu of scoring, the film may be embossed.

FIG. 2 illustrates an assembly 12 which may be used in the process of the invention. The assembly comprises a glass sheet 14, a laminating layer 10 with scores 11, 11a on its two surfaces, and a glass sheet 14 on the other surface having a thickness of from about 0.5 mm to 1.5 mm which prevents spalling when the laminate is struck by an object on it's outer side.

FIG. 3 illustrates the assembly 12 after undergoing treatment under heat and pressure pursuant to the invention whereby a unitary resinous layer 11 is found free of any bubbles.

FIG. 4 illustrates another form of laminate 15, which may be prepared by the process of the invention wherein laminating layers 17, which were scored or embossed on both sides, are bound to multiple layers of glass sheets 18, with all or at least the bottom glass sheet having a thickness of about 0.5 to 1.5 mm.

FIG. 5 illustrates an embossed laminating film.

According to the process of the invention, an extruded film comprising a copolymer of an olefin and from 13 to 22% by weight of a methacrylic or acrylic acid which has been neutralized 40 to 90% with an alkali metal cation and which has a Tg of less than 210° F. is used as the laminating layer.

The laminating layer, which is generally extruded to 4-60 mils in thickness, is cut into a desired form for example, 12 inch squares, or not cut and continuously passed through a scoring apparatus to groove both sides. The cut grooved sheets are then cleaned with isopropanol and stacked on a primed outer sheet or between two primed sheets of glass. One of which sheet is an inner sheet leaving a thickness of about 0.5 to 1.5 mm. The amount of sheets utilized for the outer layer depends on the types of glass desired. An overall thickness of of the laminate about 4-60 mils is generally sufficient for the different uses. The stacked assembly is subjected to heat and pressure or vacuum sufficient to cause permanent adherence of one glass layer to another through the laminating resin layer. Desirably, the stacked assembly is passed through rollers to lightly adhere the layers together. Preferably the assembly is placed in a so-called “polymar” bag of the type disclosed in U.S. Pat. No. 3,311,517. The bag comprises an outer ply of polyethylene terephthalate and an inner layer of polyethylene. The bag is generally inserted into a second bag of the same material evacuated and sealed. The sealed bag is placed in an autoclave at a temperature of about 255-280° F. for about 3-20 minutes under about 20-200 psi pressure in a vacuum.

The assembly is then cooled to about 150° F. within about 30 to 45 minutes to avoid clouding and the pressure is reduced.

The thickness of the outer layers in accordance with this invention can be selected to be variable depending on the purpose for which they are used. The number of individual layers of the composite article is likewise selectable as desired. However, the anti-spalling inner layer must be about 0.5 to 1.5 mm. This makes the article useful in the construction field in connection with doors and door systems, in windows and window constructions, in buildings and houses in violent storm areas such as tornados and hurricanes. The laminates are especially useful for airplanes which may impact with birds or automobiles whose windows are struck by road hazards or projectiles.

The laminating layers are extruded copolymers comprising copolymers of olefins, preferably having ethylene groups, and 13 to 22% by weight of methacrylic or acrylic acid monomers which have been neutralized from 40 to 90% preferably with an alkali metal cation and contains a diamine. The bonding layer has a Tg of less than 210° F. However, the laminating film can be 100% neutralized and contain no diamine.

The laminating film contains 0 to 5% by weight of a diamine which has at least one R—CH₂—NH₂ group, and the R may contain: (CH₂NH₂)ₓ; and, (R′R″NH)_{y}, where x=1 or more, and y=o or more. R′ and Rₓ″ may be any organic groups. The preferable structure of the diamine is:

NH₂CH₂—(R)—CH₂NH₂

Where R contains from one to 12 carbon atoms; R may be aliphatic or alicyclic; and R may also contain:

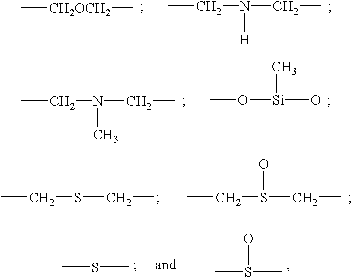

Examples of the preferred diamines which can be used are

1,12-diaminododecane;

2-methyl-1,5-pentanediamine;

1,6-diaminohexane;

Bis (1,3-aminomethy) cyclohexane (BAG); and

1,3-diaminomethylxylene.

The copolymer prior to the diamine addition may already be partially neutralized from 40 to 90% with an alkali metal cation such as sodium or other alkali metal salt.

Any of the usual types of glass used in so-called safety applications can be used in conjunction with the process of the present invention including chemically and thermally strengthened or tempered glass as well as common untempered glass where indicated. Amongst the glasses which may be used are silicate glass, E-glass, Toro® glass, etc. The type used depends upon the intended use of the laminate. The nature and composition of some of the various glasses is known in the art and described, for example, in the “Encyclopedia of Chemical Technology” by Kirk-Othmer, published by Interscience Encyclopedia Inc. New York, N.Y., Vol. 7, pages 181-189, et seq., which is herewith incorporated by reference.

U.V. absorbers or blockers which can be used in an amount of from 0.01 to 2% by weight include the hydroxybenzophennols, oxanilide compounds, benzotriazoles, and the like as disclosed in Modern Plastics Encyclopedia, McGraw-Hill, Inc. 1982.

Primers, particularly suitable for glass, and the glass/copolymer interface include silanes such as those produced under the registered trademarks “Z-6040” and “Z-6020” by Dow Chemical Company may also be used.

Although, embossed or knurled surfaces can be used on the laminating layer, scoring indentations are preferred since it permits a flat bonding surface while embossing distorts the surface into raised portions which may create pockets with the glass covering of not properly compressed during laminating.

The present invention is further illustrated by the following examples.

### EXAMPLE 1

A windshield or windscreen was prepared by stacking 50 mil of an extruded sheet of polyethylene/methacrylic acid copolymer neutralized with sodium cations according to the invention, which has been scored on both surfaces on an outboard layer of 250 mils of chemically strengthened glass coated with Z-6040 primer of Dow Chemical Company. An inboard layer of 1.5 mils of chemically tempered glass, as disclosed in U.S. Pat. No. 3,395,998, and commercially available from PPG Glass Company of Pittsburg, Pa. is used to complete the assembly. The assembly was placed in a vacuum bag and heated to 250° F. for 45 minutes in an autoclave. The pressure was released and the assembly cooled to about 150° F. in 30 minutes. The laminate can then be placed in a suitable glazing structure. The laminate was free of bubbles and optically clear.

### EXAMPLE 2

A diamine cross-linked partially (40%) neutralized with sodium cations ethylene-methacrylic acid copolymer containing 0.01% U.V. absorber was added to the resin port of a small extruder having an extruding barrel temperature which was maintained at 325°-400° F. A film (50 mils) was extruded, scored and cut into twelve-inch squares and then stacked between a one-eighth inch sheet of tempered glass plates and a 4 mils. thick chemically treated glass. The assembly was placed in a so-called “polymar” bag of the type disclosed in U.S. pat. No. 3,311,517 to Keslar et al. The bag is comprised of polyethylene terephthalate. The bag was inserted into a second bag of the same material, evacuated and sealed. The sealed unit was placed in an autoclave at 280° F., for 2 hours under 20 psi pressure in a vacuum. The unit was then cooled to 150° C. in 30 minutes and the pressure reduced. The assembly was removed from the autoclave and the bags and plastic wrapping were removed from the assembly.

The resulting bubble-free laminate is then ready to insert into a suitable support or frame and secured therein.

The form of the invention shown and described herein represents an illustrative preferred embodiment and variations thereof. It is understood that various changes may be made without departing from the gist of the invention as defined in the claims

What is claimed is:

1. A method for preparing a non-spalling transparent laminated article which comprises the steps of;
A. providing a multiplicity of indentions or contiguous grooves or scores on the surfaces of a laminating film, said laminating film comprising an extruded copolymer of an olefin and 13 to 22% by weight of an alpha olefin carboxylic acid which is at least partially neutralized with an alkali metal cation,
B. placing a first sheet of glass in contact with one of the grooved surfaces of said laminating film;
C. placing a second sheet of glass having a thickness of about 0.5 to 1.5 mm on the side of the laminating film, and then;
D. applying heat and pressure or vacuum to the assembly to form a laminate.

2. The method of claim 1 wherein said bonding film and sheet are heated under a pressure of about 20 to 200 psi and a temperature of about 225 to 280° F.

3. The method of claim 1 wherein said laminating film comprises an extruded copolymer of ethylene and methacrylic or acrylic acid monomers at least partially neutralized with an alkali metal cation.

4. The method of claim 3 wherein said laminating film is 100% neutralized.

5. The method of claim 1 wherein said copolymer includes 0 to 5% by weight of a diamine.

6. The method of claim 2 wherein said colpolymer contains about 0.01 to 2.5% by weight of ultraviolet blocker.

7. An anti-spalling laminated safety glass prepared by the method of claim 1.

8. The laminate of claim 7 having a thickness of about 4 to 60 mils.

9. An anti-spalling laminated safety glass prepared by the method of claim 2.

10. An anti-spalling laminated safety glass prepared by the method of claim 3.

11. An anti-spalling laminated safety glass prepared by the method of claim 4.

12. An anti-spalling laminated safety glass prepared by the method of claim 5.

13. An anti-spalling laminated safety glass prepared by the method of claim 6.
